(19) United States
(12) Patent Application Publication
(10) Pub. No.: US 2023/0211435 A1
(43) Pub. Date: Jul. 6, 2023

(54) LASER MACHINING SYSTEM

(71) Applicant: Mitsubishi Electric Corporation, Tokyo (JP)

(72) Inventors: Motoaki NISHIWAKI, Tokyo (JP); Kenta FUJII, Tokyo (JP); Kyohei ISHIKAWA, Tokyo (JP)

(73) Assignee: Mitsubishi Electric Corporation, Tokyo (JP)

(21) Appl. No.: 17/927,369

(22) PCT Filed: May 29, 2020
(86) PCT No.: PCT/JP2020/021332

§ 371 Date: Nov. 23, 2022

(51) Int. Cl. B23K 26/03; B23K 26/042

(52) U.S. Cl. CPC B23K 26/03; B23K 26/042

(57) ABSTRACT

A laser machining system includes a state measurement unit that observes an internal state of a machining head or a varying state of a workpiece and outputs a machining state signal; an inference unit that determines a degree of quality of the laser beam machining as an inference result for each of machining defects concerning at least one type of machining defect on the basis of the machining state signal; a machining monitoring unit that monitors the workpiece for presence or absence of the machining defect and outputs a monitoring signal; a machining decision unit that decides whether there is the machining defect and determines a quality of the machining as a decision result; and a machinery safety unit that outputs, on the basis of the inference result and the decision result, a control signal that gives an instruction on whether to stop or continue the laser beam machining.

### FIELD

The present disclosure relates to a laser machining system that machines a workpiece with a laser beam.

### BACKGROUND

A user has often used standard machining conditions that are machining conditions prepared by a manufacturer for machining workpieces with a laser machining system. Machining parameters and parameter values are set in the standard machining condition for each material or thickness of the workpiece that are used for laser beam machining. However, there are many cases where desired machining qualities cannot be obtained even when the standard machining conditions are used for machining, so that the user modifies the machining conditions during production.

In view of such background, application of machine learning techniques to machine tools has attracted attention. For example, there is ongoing technical research on anomaly detection or predictive maintenance of systems. In a system equipped with a machine learning technique, there are cases where an inference result is false or overlooked. In order to prevent an unintended movement of a user's machining apparatus, which is caused from control utilizing machine learning combined with a conventional method from causing and leads to suspension of the machine, ensured safety of the system is necessary.

Techniques that ensure safety of machine learning devices have been proposed. For example, Patent Literature 1 discloses a controller and a machine learning device. The safety of the machine learning device is ensured by preparing an input safety circuit and an output safety circuit and detecting anomalous values with at least one of the safety circuits. The input safety circuit detects anomalous values such as noise from internal data and external data that a state observation unit measures from a manufacturing machine and outputs safe input data, and the output safety circuit detects anomalies in inference data.

Patent Literature 2 discloses an anomaly detection system and a model generation method that, for generating a highly accurate anomaly detection model before actual operation, generate plural features from state values stored in a state value storage unit, calculate degrees of importance that are degrees effective in anomaly detection on the basis of the generated features, and determine integration of the degrees of importance and a ranking of the features according to plural methods. In other words, the techniques disclosed in Patent Literatures 1 and 2 reduce misdecisions with the devised pre- and post-processings in machine learning or with the higher accuracy of the model.

### CITATION LIST

### Patent Literature

Patent Literature 1: Japanese Patent Application Laid-open No. 2019-86928
Patent Literature 2: Japanese Patent Application Laid-open No. 2019-185530

### SUMMARY

### Technical Problem

The technique disclosed in Patent Literature 1 provides detection of an anomalous value such as noise or an outlier in advance when data is input to the machine learning device, thus enabling reduction of influence of the anomalous value as far as possible and increased accuracy of learning data. Moreover, the technique disclosed in Patent Literature 1 enables detection of an anomalous value even in an output result of the machine learning device or modification of the result, thus enabling a user to safely use the machine learning device. However, even with the increased accuracy of the learning data, the technique disclosed in Patent Literature 1 cannot eliminate misdecisions from output results of the machine learning device or undetected ones. In addition, the technique disclosed in Patent Literature 1 requires a human to decide whether the output result of the machine learning device is a misdecision.

When optimizing a compensation value to be added to a control command for a servomotor, the technique disclosed in Patent Literature 2 ensures a safety functionality by providing a limiting unit that provides a limited range of control commands for preventing the control command with the added compensation value from causing unstable operation. However, in cases where plural variables such as machining parameters are optimized while a machine tool performs machining, simply providing the limiting unit may not enable continued machine learning inference. In other words, with the technique disclosed in Patent Literature 2, there is a possibility of anomalous operation due to a control command based on a result of machine learning inference.

The present disclosure has been made in view of the above, and an object of the present disclosure is to obtain a laser machining system that prevents suspension of a machine even when a result of machine learning inference is false or overlooked.

### Solution to Problem

To solve the above problems and achieve an object, a laser machining system according to the present disclosure includes: a driving unit to change relative positions of a machining head that focuses a beam emitted from a laser oscillator in irradiating a workpiece and the workpiece; a control unit to determine operation commands for the driving unit and the laser oscillator on a basis of a control signal and a machining condition specifying parameters and numerical values for laser beam machining; a state measurement unit to observe, during laser beam machining, an internal state of the machining head or a varying state of the workpiece and output an observation result as a machining state signal; an inference unit to determine a degree of quality of the laser beam machining as an inference result, the degree of quality being inferred for each of machining defects concerning at least one type of machining defect on a basis of the machining state signal; a machining monitoring unit to monitor the workpiece for presence or absence of the machining defect and output a monitoring result as a monitoring signal; a machining decision unit to decide whether or not there is the at least one type of machining defect on a basis of the monitoring signal and determine a quality of the laser beam machining as a decision result; and a machinery safety unit to output, on a basis of the inference result and the decision result, the control signal that gives an instruction on whether to stop or continue the laser beam machining.

### Advantageous Effects of Invention

The laser machining system according to the present disclosure is effective in preventing suspension of a machine even when a result of machine learning inference is false or overlooked.

### BRIEF DESCRIPTION OF DRAWINGS

FIG. 1 is a diagram illustrating a configuration of a laser machining system according to a first embodiment.

FIG. 2 is a flowchart illustrating an operational procedure of the laser machining system according to the first embodiment.

FIG. 3 illustrates an example of a workpiece's surface where gouging has occurred.

FIG. 4 illustrates an example of a workpiece's cut surface with machining flaws generated.

FIG. 5 is a diagram illustrating an example of a machine learning model to be used in cases where an inference unit of the laser machining system according to the first embodiment uses machine learning in performing decision processing.

FIG. 6 is a diagram illustrating an example of a configuration of the inference unit in the laser machining system according to the first embodiment.

FIG. 7 is a diagram illustrating an example of decision processing that a machining decision unit of the laser machining system according to the first embodiment performs using signal processing.

FIG. 8 is a diagram illustrating a configuration of a laser machining system according to a second embodiment.

FIG. 9 is a diagram illustrating machining tolerance.

FIG. 10 is a flowchart illustrating an operational procedure of the laser machining system according to the second embodiment.

FIG. 11 is a diagram illustrating a configuration of a laser machining system according to a third embodiment.

FIG. 12 is a diagram illustrating variation of the machining tolerance according to material states and machining states.

FIG. 13 is a flowchart illustrating an operational procedure of the laser machining system according to the third embodiment.

FIG. 14 is a diagram illustrating a processor in cases where the processor is used to implement at least part of the inference unit, the machining decision unit, a machinery safety unit, a corrective machining condition determination unit, a control unit, a display unit, and an input unit of a controller of the laser machining system according to the first embodiment.

FIG. 15 is a diagram illustrating processing circuitry in cases where the processing circuitry is used to implement at least part of the inference unit, the machining decision unit, the machinery safety unit, the corrective machining condition determination unit, the control unit, the display unit, and the input unit of the controller of the laser machining system according to the first embodiment.

### DESCRIPTION OF EMBODIMENTS

With reference to the drawings, a detailed description is hereinafter provided of laser machining systems according to embodiments.

### First Embodiment

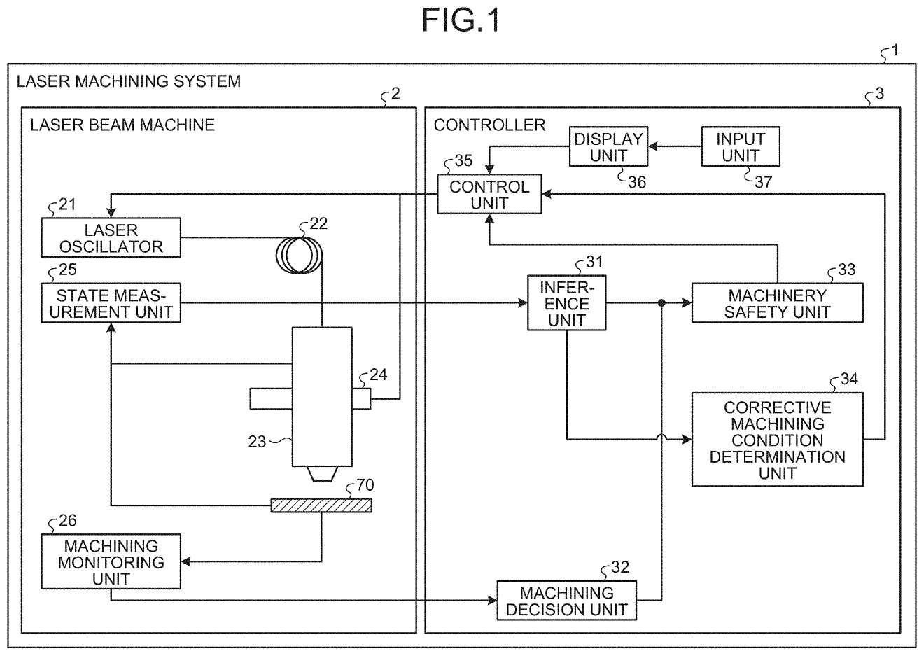

FIG. 1 is a diagram illustrating a configuration of a laser machining system 1 according to a first embodiment. The laser machining system 1 is a system that machines a workpiece 70 with a laser beam. FIG. 1 also illustrates the workpiece 70. The laser machining system 1 includes a laser beam machine 2 that emits a laser beam and a controller 3 that controls the laser beam machine 2. The laser beam machine 2 includes a laser oscillator 21, an optical path 22, a machining head 23, a driving unit 24, a state measurement unit 25, and a machining monitoring unit 26.

The laser oscillator 21 emits an oscillated laser beam on the basis of an operation command that is determined by the control unit 35 of the controller 3. A detailed description of the controller 3 is described later. The laser oscillator 21 may be a device capable of switching of emission between continuous wave oscillation and pulsed oscillation. If the laser oscillator 21 performs pulsed oscillation, a pulse frequency and a duty may be set for the laser oscillator 21. The laser oscillator 21 may be a device that performs only one of the continuous wave and pulsed oscillations.

The laser oscillator 21 is not limited to a certain type. The laser oscillator 21 may be, for example, a gas laser such as a carbon dioxide laser or a solid-state laser using, for example, an yttrium aluminum garnet (YAG) crystal as a medium. The laser oscillator 21 may be a fiber laser using an optical fiber as an excitation medium or a direct diode laser that couples laser beams emitted from laser diodes. The laser beam machine 2 may include a plurality of laser oscillators including the laser oscillator 21.

The laser beam emitted from the laser oscillator 21 is transmitted to the machining head 23 via the optical path 22. The optical path 22 is a transmission path to the machining head 23 for the laser beam emitted from the laser oscillator 21. The optical path 22 may be a propagation path for the laser beam through air with the use of, for example, a mirror or a transmission path for the laser beam through an optical fiber. The optical path 22 is appropriate to the oscillation method, the type, and output power of the laser oscillator 21 as well as a wavelength and characteristics of the laser beam.

The machining head 23 focuses the laser beam and irradiates the workpiece 70 with the laser beam. By being irradiated with the laser beam by the machining head 23, the workpiece 70 is machined. For example, the workpiece 70 is cut by being irradiated with the laser beam by the machining head 23. In order to cut the workpiece 70 properly, the machining head 23 includes an optical system that focuses the laser beam to an appropriate point. The optical system is not illustrated. An Example of an element included in the optical system is a converging lens or a lens cartridge.

A machining gas is supplied into the machining head 23. The machining head 23 supplies the machining gas to the workpiece 70 when irradiating the workpiece 70 with the laser beam. The machining head 23 includes a gas passage for supplying the machining gas to the workpiece 70. The gas passage is not illustrated. It is preferable that the machining head 23 has functions to supply the machining gas to the workpiece 70 at a pressure appropriate to a thickness of the workpiece 70.

A machining nozzle is attached to a leading end of the machining head 23. The machining nozzle is not illustrated. The machining nozzle includes an opening. The opening is formed, for example, on an optical path between the converging lens and the workpiece 70. The laser beam and the machining gas pass through the opening. In order for the laser beam to be focused to the appropriate point for the workpiece 70, the machining nozzle desirably has either a function of detecting a distance between the machining head 23 and the workpiece 70 or a function of detecting a relative position of the machining head 23 with respect to the workpiece 70 or both.

The driving unit 24 has a function of changing relative positions of the machining head 23 and the workpiece 70 on the basis of a control signal that is determined by the control unit 35 of the controller 3. In other words, the driving unit 24 changes the relative positions of the machining head 23, which focuses the beam emitted from the laser oscillator 21 and irradiates the workpiece 70, and the workpiece 70. The driving unit 24 may move the machining head 23 to a specified position at a command speed. The driving unit 24 may move a machining pallet on which the workpiece 70 is placed to a specified position at a command speed. The machining pallet is not illustrated.

The driving unit 24 is, for example, a servo controller including a linear motor and a position detector. The driving unit 24 may be a device using a drive system that uses a motor and a gear or a drive mechanism with a rotating shaft. For example, the driving unit 24 includes a motor that rotates under the control of the controller 3, thus changing the relative positions of the machining head 23 and the workpiece 70.

The state measurement unit 25 measures an internal state of the machining head 23 or a state of the workpiece 70 from when machining starts until the machining ends. More specifically, the state measurement unit 25 observes the internal state of the machining head 23 or the varying state of the workpiece 70 during the laser beam machining and outputs an observation result as a machining state signal. The state measurement unit 25 may measure the internal state of the machining head 23 and the state of the workpiece 70 from when the machining starts until the machining ends. The state measurement unit 25 may detect reflected light that is generated during machining and travels to the laser oscillator 21 via the optical path 22. The state measurement unit 25 starts the measurement on the basis of a machining start command and a signal. The state measurement unit 25 may be an autonomous measurement device that does not require human work as an intervention. A measurement start command may be written in a machining program that is used for machining.

The state measurement unit 25 measures at least one of: amplitudes and intensities of scattered light and reflected light that are generated during machining; a sound spectrum and sound intensity of the machining gas; or component temperature inside the machining head 23. The state measurement unit 25 quantifies information obtained from the measurement in the form of a state variable indicating a machining state. The state measurement unit 25 outputs a quantified detection result as a machining signal to the controller 3.

The state measurement unit 25 is, for example, an optical sensor such as a photodiode, a charge-coupled device (CCD) sensor, a complementary metal-oxide-semiconductor (CMOS) sensor, or a spectroscope, an acoustic sensor such as a microphone, a pressure sensor, or a temperature sensor such as a thermocouple. The state measurement unit 25 may be a device combining plural of the above optical, acoustic, pressure, and temperature sensors. As in the above, the state measurement unit 25 may include at least one of an acoustic sensor, an optical sensor, an acceleration sensor, or a temperature sensor.

The laser beam machine 2 may include a plurality of state measurement units including the state measurement unit 25. In cases where the laser beam machine 2 includes the plurality of state measurement units, the plurality of state measurement units may be of different types.

The machining monitoring unit 26 measures machining defects that occur at a front and a back face of the workpiece 70. The front face of the workpiece 70 is one of two faces of the workpiece 70 that is irradiated with the laser beam. The back face of the workpiece 70 is an opposite one of the two faces of the workpiece 70 from the front face. In other words, the machining monitoring unit 26 monitors the workpiece 70 for any machining defects and outputs a monitoring result as a monitoring signal. More specifically, in accordance with a monitoring signal and a command that are output from the control unit 35 of the controller 3, the machining monitoring unit 26 measures either a state of the front face of the workpiece 70 or a state of the back face of the workpiece 70 or both. A measurement start command may be written in the machining program that is used for machining.

The machining monitoring unit 26 measures part or all of temperature transition, emission intensity, and an image for either or both of the front and back faces of the workpiece 70 and quantifies the state of the workpiece 70, such as the presence or absence of molten material and an area of the molten material. As with the state measurement unit 25, the machining monitoring unit 26 outputs a quantified result as a machining signal to the controller 3. The machining monitoring unit 26 is, for example, an optical sensor such as a photodiode, a network camera, a laser imaging, detection, and ranging (LiDAR) camera, or a time-of-flight (ToF) camera, a temperature sensor such as a radiation thermometer, or a distance sensor such as a tactile sensor or an ultrasonic sensor. The machining monitoring unit 26 may be a device combining plural of the above optical, temperature, and distance sensors. As in the above, the machining monitoring unit 26 may include at least one of an acoustic sensor, an optical sensor, a camera, a vibration sensor, or a distance sensor.

The machining monitoring unit 26 may be installed around the machining head 23 or at the driving unit 24 and may operate in synchronization with the machining head 23 or the driving unit 24. The laser beam machine 2 may include a plurality of machining monitoring units including the machining monitoring unit 26. The machining monitoring unit 26 measures a limited area of the workpiece 70. A value obtained by the machining monitoring unit 26 makes a relatively great contribution to machining defect detection and, therefore, is weighted more heavily than a value obtained by the state measurement unit 25 in undergoing numerical processing in the controller 3.

The controller 3 includes an inference unit 31, a machining decision unit 32, a machinery safety unit 33, a corrective machining condition determination unit 34, the control unit 35, a display unit 36, and an input unit 37. For machining, the controller 3 controls the laser beam machine 2. The inference unit 31 determines a degree of quality of laser beam machining as an inference result. The degree of quality is inferred for each of machining defects about at least one type of machining defect on the basis of the machining state signal from the state measurement unit 25. In other words, the inference unit 31 infers a machining state of the workpiece 70. For example, the inference unit 31 uses machine learning for inferring the machining state of the workpiece 70.

The machining decision unit 32 decides whether or not there is at least one type of machining defect on the basis of the monitoring signal from the machining monitoring unit 26 and determines a quality of laser beam machining as a decision result. In other words, the machining decision unit 32 detects a machining anomaly of the workpiece 70. In cases where the machining state is poor, the corrective machining condition determination unit 34 generates correction quantities for modifying a machining condition to a proper machining condition and generates the corrected machining condition based on the correction quantities. More specifically, the corrective machining condition determination unit 34 corrects the machining condition on the basis of the inference result obtained by the inference unit 31 in determining the corrected machining condition. The corrective machining condition determination unit 34 outputs the corrected machining condition to the control unit 35.

The machinery safety unit 33 outputs to the control unit 35 a control signal that gives an instruction on whether to stop or continue the laser beam machining on the basis of the inference result obtained by the inference unit 31 and the decision result obtained by the machining decision unit 32. The control unit 35 determines operation commands for the driving unit 24 and the laser oscillator 21 on the basis of the control signal and the machining condition that specifies parameters and numerical values for laser beam machining. More specifically, the control unit 35 receives the control signal output from the machinery safety unit 33 and the corrected machining condition output from the corrective machining condition determination unit 34.

The display unit 36 is a human-machine interface that displays an image for receiving inputs from a user as well as internally generated information of the controller 3. Using the display unit 36, the user can, for example, specify a machining program and input machining conditions. The display unit 36 displays the results obtained by the inference unit 31 and the machining decision unit 32. The display unit 36 is implemented with a display or a monitor. A place in which the display unit 36 is installed is not limited. The display unit 36 may be integrated with the control unit 35 or the input unit 37.

The input unit 37 accepts information input by the user and outputs the accepted information to a constituent element that handles the accepted information among the plurality of constituent elements of the controller 3. The input unit 37 is implemented, for example, with a keyboard or a mouse. The input unit 37 and the display unit 36 may be integrated to implement a software keyboard.

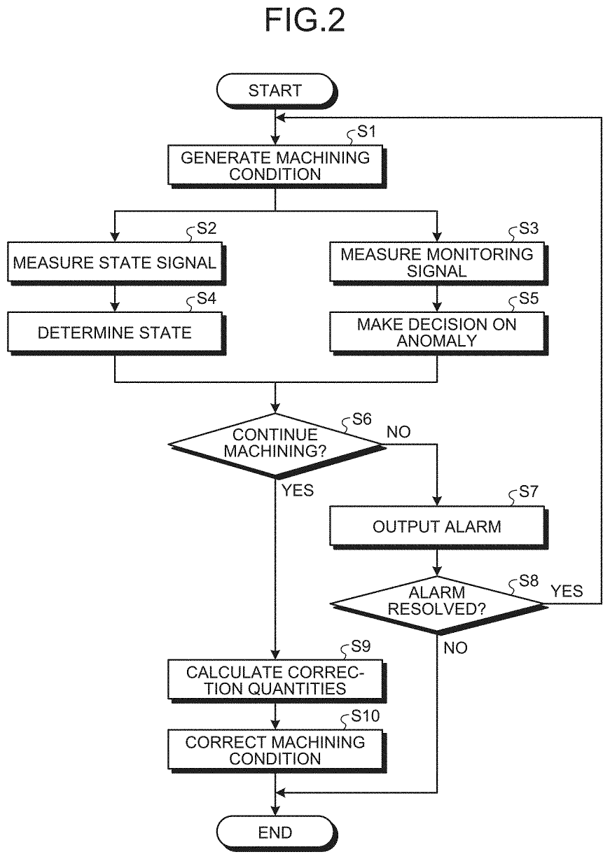

FIG. 2 is a flowchart illustrating an operational procedure of the laser machining system 1 according to the first embodiment. The laser machining system 1 generates a machining condition for machining first (S1). Specifically, the corrective machining condition determination unit 34 of the controller 3 generates the machining condition. The machining condition to be generated may be determined on the basis of a machining state inferred by the inference unit 31 or may be specified by the user.

Next, the laser machining system 1 performs the machining based on the machining condition generated at step S1. The workpiece 70 is irradiated with a laser beam emitted from the laser oscillator 21, and the state measurement unit 25 detects the varying state of the workpiece 70 and the internal state of the machining head 23 (S2). In FIG. 2, the operation of step S2 is phrased as “MEASURE STATE SIGNAL”. The machining monitoring unit 26 detects the varying state of the front face and/or the varying state of the back face of the workpiece 70 during the machining (S3). In FIG. 2, the operation of step S3 is phrased as “MEASURE MONITORING SIGNAL”.

The inference unit 31 extracts a feature based on a detection result of the state measurement unit 25 and determines, with the feature, a quality of the machining (S4). In FIG. 2, the operation of step S4 is phrased as “DETERMINE STATE”. The feature may be a value extracted from a taken image of a cut section of the workpiece 70 or a frequency at which the sound spectrum of the machining gas has peaks. Any feature is acceptable as long as the feature is usable in the determination of the quality of the machining. The machining decision unit 32 detects a machining defect on the basis of a detection result of the machining monitoring unit 26 through decision using a threshold or an image (S5). In FIG. 2, the operation of step S5 is phrased as “MAKE DECISION ON ANOMALY”.

The machinery safety unit 33 determines whether to continue the machining or not on the basis of an inference result obtained by the inference unit 31 and a decision result obtained by the machining decision unit 32 (S6). Specifically, the machinery safety unit 33 determines that the machining be continued if the inference result obtained by the inference unit 31 indicates good machining, with the decision result obtained by the machining decision unit 32 indicating no defect. If the machining decision unit 32 determines the anomaly, the machinery safety unit 33 determines that the machining be suspended, regardless of the result obtained by the inference unit 31.

If the machinery safety unit 33 determines that the machining be suspended (No to S6), the machinery safety unit 33 outputs an alarm (S7). The laser machining system 1 determines whether or not the alarm has been resolved (S8). If the laser machining system 1 decides that the alarm has been resolved (Yes to S8), the laser machining system 1 performs the operation of step S1. If the laser machining system 1 decides that the alarm is not resolved (No to S8), the operation of the laser machining system 1 ends.

If the machinery safety unit 33 determines that the machining be continued (Yes to S6), namely if the machinery safety unit 33 outputs a control signal for continued machining, the corrective machining condition determination unit 34 calculates correction quantities appropriate to the decision result obtained by the inference unit 31 (S9). The corrective machining condition determination unit 34 modifies the machining condition on the basis of the correction quantities, thus generating a corrected machining condition (S10). The laser machining system 1 performs machining based on the modified machining condition. As described above, the laser machining system 1 is a system achieving bistability based on the monitoring result and the inference result.

A description is hereinafter provided of an example in which the laser machining system 1 cuts the workpiece 70. Note that, for example, when a method of evaluating machining results is changed to a method appropriate to a machining type, the laser machining system 1 can perform machining other than cutting, such as drilling.

Machining defects that may occur to the workpiece 70 can be divided roughly into two categories: accidental machining defects and machining defects due to changes in the workpiece 70 or the machining head 23 over time. Examples of a factor of the accidental machining defects include contamination and burning of glass or a lens included in a plurality of constituent elements of the laser beam machine 2 during machining, damage to or deformation of the machining nozzle, and the like. The accidental machining defects are difficult to detect before their occurrence. A machining defect caused by heat accumulation in the workpiece 70 or an internal optical component of the machining head 23 because of machining for a relatively long time is an example of the machining defect due to the changes over time.

There are plural types of machining defects. Specifically, a defect results from gouging, burning, or bursting appears on a surface of the workpiece 70. Furthermore, a defect in which molten material is generated on the back face of the workpiece 70. The melt is dross. Machining defects such as a peeled-off oxide film, a machining flaw, a rough cut section, and a defect caused by plasma appear only on cut surfaces of the workpiece 70, not on the front and back faces.

Machining defects other than the above-mentioned machining defects may be added as machining defects to be detected. For example, a discolored cut surface that is associated with purity of the machining gas or a machining defect associated with vibration of a surface due to mechanical vibration of the laser beam machine 2 may be added. Depending on a type of machining gas that is used for machining, machining defects that occur may differ. For example, in cases where oxygen cutting that uses oxygen as the machining gas is performed, an oxide film is generated on a cut surface, resulting in a machining defect in the form of a peeled-off oxide film. However, no oxide film is generated on a cut surface in cases where nitrogen cutting that uses nitrogen as the machining gas is performed. Therefore, the peeled-off oxide film does not have to be included as a machining defect in that case.

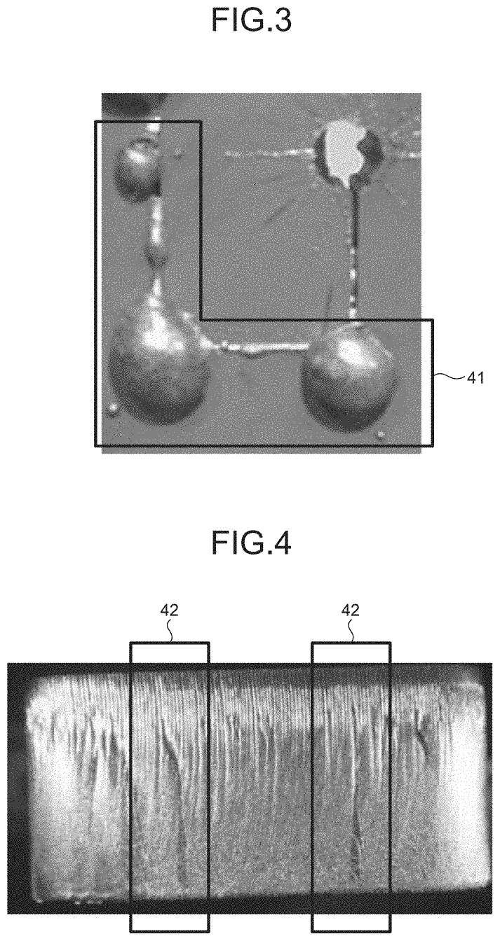

FIG. 3 illustrates an example of a surface of the workpiece 70 where gouging has occurred. As illustrated in a part 41, the gouging occurs when molten metal rises locally on a cut surface. Therefore, whether or not gouging has occurred may be determined on the basis of, for example, a taken image of the surface of the workpiece 70.

FIG. 4 illustrates an example of a cut surface of the workpiece 70 with machining flaws generated. As illustrated in parts 42, machining flaws occur locally, extending from an upper part to a lower part of the cut surface. Therefore, whether or not the machining flaw has occurred may be determined on the basis of, for example, differences in brightness among pixels of a taken image of the cut surface. The machining defects that the machining monitoring unit 26 can measure, occur on the front or back face of the workpiece 70 and once such a machining defect occurs, immediate modification of the machining condition is needed.

The inference unit 31 analyzes a time-series signal or numerical information obtained from the state measurement unit 25, determines a feature representing a machining state, infers a degree of quality of machining or a type of machining defect, and outputs an inference result. A method that the inference unit 31 executes for determining the quality is, for example, a method of determining the quality of the machining on the basis of what has been learned in advance through machine learning called supervised learning. The type of machining defect that the inference unit 31 outputs refers to, for example, gouging, burning, dross, a peeled-off oxide film, a burr, a rough top face, surface roughness, plasma, or bursting.

A result indicative of the quality that the inference unit 31 outputs may be a value indicating only goodness or poorness as a result, an evaluation value indicating a degree of goodness or poorness, or information indicating a likelihood of goodness or poorness. For example, the inference unit 31 may output information indicating that the likelihood of goodness is 755. In cases where the inference unit 31 outputs a result on a single machining defect out of a plurality of defects, the inference unit 31 may output, for the machining defect that has occurred, any evaluation value in a range of 0 to 1, or one of at least three evaluation values such as 0, 0.5, and 1, in which 0 and 1 are respectively a lower-limit and an upper-limit evaluation value and are defined respectively as poor and good.

In cases where the inference unit 31 outputs a result on a plurality of machining defects, the inference unit 31 may output, for each of the defects, any evaluation value in the range of 0 to 1 or one of at least three evaluation values such as 0, 0.5, and 1. The inference unit 31 may determine the degree of quality of the machining or the type of machining defect on the basis of a sum of the evaluation values for the machining defects. Alternatively, the inference unit 31 may decide that a result on quality of a cut section indicates poorness if there is even one machining defect.

A criterion on whether machining is good or poor may differ depending on the user. The inference unit 31 may decide whether or not the evaluation value for the machining defect indicates goodness on the basis of a threshold determined by the user.

Examples of the feature that the inference unit 31 uses in the decision include an average value and a standard deviation of a time-series signal obtained from the state measurement unit 25. The inference unit 31 converts the feature into sets corresponding to the feature and evaluates a degree of poorness of a defect in each of machining segments on the basis of a difference of each of the sets from a reference value. A method of determining the feature is changed in accordance with a configuration or a type of the state measurement unit 25.

There are plural methods of determining the feature. The feature may be, for example, a set of values obtained by statistical analysis or frequency analysis of a time-series signal obtained from the state measurement unit 25 or analysis of the time-series signal that uses a conversion method, such as filterbank analysis. The feature may be determined with a general analysis method for time-series signals.

The inference unit 31 can use, for the feature obtained by analyzing the time-series signal from the state measurement unit 25, a method that uses a classifier such as linear discrimination, logistic regression, a support-vector machine, a relevance vector machine, or a decision tree, and a regression method such as linear regression, polynomial regression, Bayesian linear regression, or Gaussian process regression. For evaluation of the machining state, a clustering technique using a K-means algorithm, mixtures of Gaussian distributions, or mixtures of Bernoulli distributions may be used.

The inference unit 31 may use an algorithm other than the above-mentioned algorithms. The algorithm other than the above may use deep learning that extracts a feature itself and learns, such as a neural network, a convolutional neural network, or a recurrent neural network that is given as a typical technique, or may use a technique combining plural of all the above algorithms.

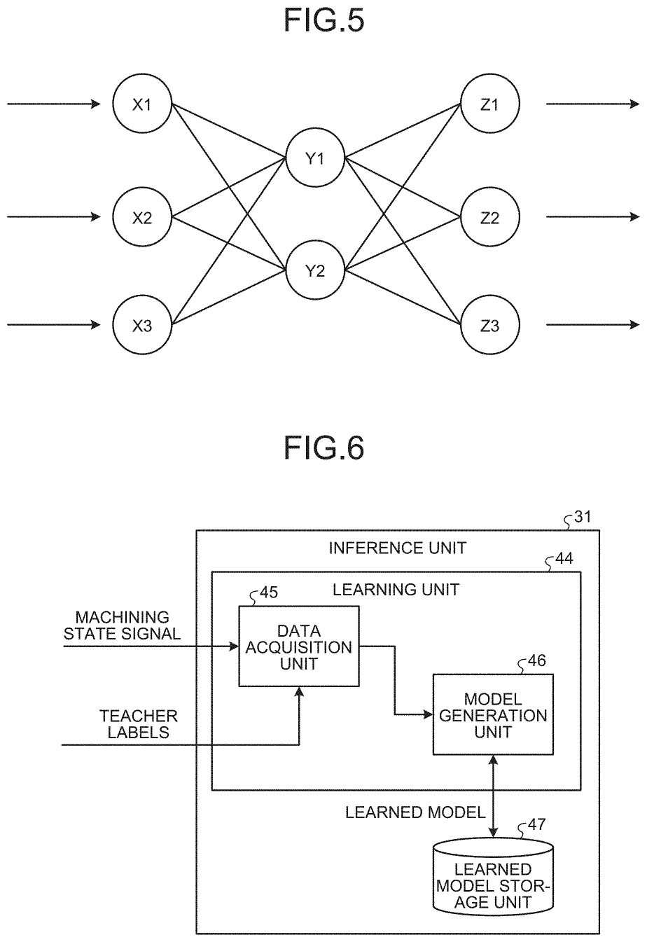

FIG. 5 is a diagram illustrating an example of a machine learning model to be used in cases where the inference unit 31 of the laser machining system 1 according to the first embodiment uses machine learning in performing decision processing. In the example illustrated in FIG. 5, a neural network is applied as the machine learning. The neural network illustrated in FIG. 5 is a three-layer neural network including nodes X1, X2, and X3 for an input layer, nodes Y1 and Y2 for an intermediate layer, and nodes Z1, Z2, and Z3 for an output layer.

Input to each of the nodes of the input layer may be current values of the motor, a machining signal indicating the amplitude or the intensity of scattered light generated during machining, or an extracted feature. In cases where machining signals are input to the nodes of the input layer, feature extraction is done by machine learning. In cases where extracted features are input to the nodes of the input layer, the features are extracted from a signal or signals measured by the state measurement unit 25 and are input to the input layer.

FIG. 6 is a diagram illustrating an example of a configuration of the inference unit 31 in the laser machining system 1 according to the first embodiment. When inferring the state of the workpiece 70, the inference unit 31 uses, for example, a learning model prepared by a manufacturer. However, there are cases where a production situation in which the user is required to machine various machining materials such as an electric-furnace material and a poor-quality material be machined, so that the prelearned model needs to be updated.

When updating the model, associating a signal output from the state measurement unit 25 with a machining result of the workpiece 70 is work that must be done in a user environment. The association of the signal from the state measurement unit 25 with the machining result may reflect a result of visual checking, photo decision, or surface roughness measurement. A new model to be added may be a classification model that separates success from failure or a regression model in which the success is 1, while the failure is 0. The machining condition may be added to inputs to the model in order for a model that is capable of more accurate determination to be learned.

The inference unit 31 illustrated in FIG. 6 includes a learning unit 44. The learning unit 44 includes a data acquisition unit 45 that obtains training data including a machining state signal output from the state measurement unit 25 and teacher labels indicating that the workpiece 70 is good and poor; and a model generation unit 46 that uses the training data obtained by the data acquisition unit 45 in generating a learned model that infers a degree of quality of laser beam machining. The inference unit 31 illustrated in FIG. 6 further includes a learned model storage unit 47 that stores the learned model generated by the model generation unit 46. The learned model storage unit 47 is implemented, for example, with a semiconductor memory.

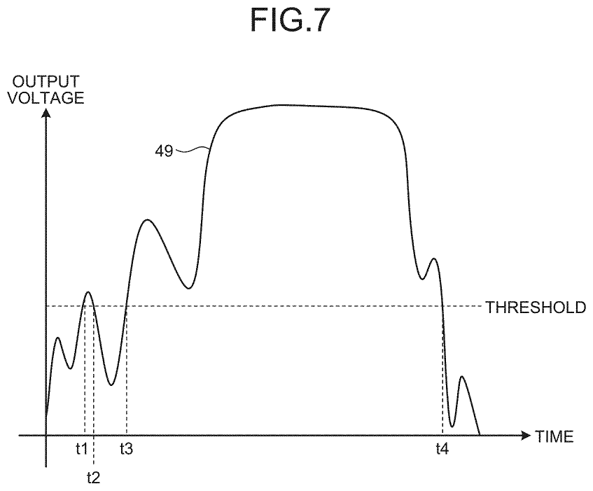

The machining decision unit 32 analyzes a time-series signal or an image obtained from the machining monitoring unit 26, detects anomalies on the front and back faces of the workpiece 70, and outputs information indicating the anomalies. FIG. 7 is a diagram illustrating an example of decision processing that the machining decision unit 32 of the laser machining system 1 according to the first embodiment performs using signal processing. In FIG. 7, a horizontal axis represents time, and a vertical axis represents output voltage that is a voltage value converted from scattered light generated during machining.

A voltage signal 49 represents the output voltage detected by the machining monitoring unit 26 during some machining. For example, the machining monitoring unit 26 decides that a machining defect has occurred when the output voltage has exceeded a threshold for a given period of time. In the example illustrated in FIG. 7, the voltage signal 49 exceeds the threshold at time t1 but is less than or equal to the threshold at time t2. If the threshold has been exceeded only temporarily, as described above, the machining monitoring unit 26 does not decide that the machining defect has occurred. The voltage signal 49 exceeds the threshold again at time t3. The machining monitoring unit 26 decides that the machining defect has occurred only when the voltage signal 49 has exceeded the threshold for a time between time t3 and time t4 that is longer than a predetermined period of time. FIG. 7 is illustrative only. A plurality of thresholds may be set as a basis for calculation of an evaluation value. A criterion on whether machining is good or poor differs depending on the user who uses the laser machining system 1. The threshold may be determined by the user.

Examples of a type of machining defect that the machining decision unit 32 outputs include gouging, burning, dross, plasma, and bursting. Since gouging, burning, bursting, and dross may cause the machining head 23 to be damaged, the laser machining system 1 needs to be stopped as soon as possible. Therefore, the machining decision unit 32 needs to detect and reliably decide such a machining defect. The machining decision unit 32 uses a detection method or image processing that does not utilize machine learning to provide an output indicating the quality of machining or the type of machining defect.

Examples of the detection method that the machining decision unit 32 uses for making a decision include a decision method that uses a threshold for a time-series signal obtained from the machining monitoring unit 26, and a decision method that uses a duration time of the time-series signal. The threshold and the duration time may be retained as numerical values for each defect or may be shared among all defects. A detection method other than the above is a method of deciding presence or absence of molten material through image recognition using a camera or through the use of a contact sensor. A method of detecting molten material or rising through LiDAR-based optical beam scanning may be carried out. A method of measuring a surface shape of the workpiece 70 with an imaging sensor may be carried out. A method of continuous measurement of a residual time of temperature with a radiation thermometer may be carried out. In cases where a plurality of sensors are used, a plurality of decision results may be used.

The machinery safety unit 33 outputs to the control unit 35 information indicating whether to stop or continue machining on the basis of both an inference result output from the inference unit 31 and a decision result output from the machining decision unit 32. The machinery safety unit 33 outputs a control signal based on a decision made by the machining decision unit 32. In cases where the decision made by the machining decision unit 32 is a decision indicating a defect, the machinery safety unit 33 outputs the corresponding control signal to the control unit 35, regardless of the inference result obtained by the inference unit 31.

More specifically, the machinery safety unit 33 determines a stop command for stopping machining when the machinery safety unit 33 determines a machining defect from a decision result on at least one type of machining defect. However, if a decision made by the machining decision unit 32 is a decision indicating no defect, while an inference result obtained from the inference unit 31 indicates a defect, the machinery safety unit 33 may prompt the machining decision unit 32 to make a redecision or request the machining decision unit 32 to change a decision cycle.

The machinery safety unit 33 may have a table of combinations of inference results obtained by the inference unit 31 and decision results obtained by the machining decision unit 32 or perform sequence control. In cases where an inference result on at least one type of machining defect indicates that the degree of quality is poor compared with a predetermined criterion, the machinery safety unit 33 determines a monitoring command that is a command for instructing the machining decision unit 32 to determine a decision result.

The control signal that the machinery safety unit 33 outputs may be a signal that cuts off energy to a motor moving a shaft of the driving unit 24 for stopping the shaft or a signal that stops beam oscillation of the laser oscillator 21. The signal to the driving unit 24 may be classified under a control command category such as stop category 0 or stop category 1 according to the machining defect generated. Stop category 0 means an uncontrolled stop, and stop category 1 means a controlled stop. The machinery safety unit 33 may output emergency stop information or alarm information. The emergency stop information or the alarm information is desirably information that prompts the user to suspend the laser machining system 1 and check a situation. The machinery safety unit 33 may prompt the machining decision unit 32 to make a redecision or may change the decision cycle of the machining decision unit 32.

In cases where, as described above, an inference result on at least one type of machining defect indicates that the degree of quality is poor compared with a predetermined criterion, the machinery safety unit 33 may determine a cyclic modulation command that is a command for instructing the machining decision unit 32 to change the decision cycle to a shorter cycle. The decision cycle is an interval of time for a decision result to be determined. The shorter decision cycle enables the machining decision unit 32 to improve its decision accuracy.

The machinery safety unit 33 may be implemented with a safety remote input/output (I/O) device, a safety relay circuit, or a safety programmable logic controller. The machinery safety unit 33 may be implemented with a numerical controller having a safety function.

The controller 3 may include a plurality of machinery safety units including the machinery safety unit 33. The machinery safety unit 33 needs to constantly communicate with the control unit 35 using control signals. A place where the machinery safety unit 33 is installed is not limited. The machinery safety unit 33 may be installed in the laser oscillator 21.

The corrective machining condition determination unit 34 determines correction quantities based on an inference result on a machining state that is obtained by the inference unit 31 to correct a machining condition, determines a corrected machining condition based on the correction quantities, and outputs the corrected machining condition to the control unit 35. On the basis of a poor state given as an output from the inference unit 31, the corrective machining condition determination unit 34 may determine machining parameters and correction quantities so that the poorness is eliminated. If good machining is in progress, the corrective machining condition determination unit 34 may determine machining parameters and correction quantities that maintain the good machining.

When eliminating machining defects, the corrective machining condition determination unit 34 makes sets of the inferred machining defects, degrees of priority in eliminating the inferred machining defects, and machining parameters that eliminate the machining defects, and holds the sets as defect avoidance data. The corrective machining condition determination unit 34 may hold machining parameters and correction quantities that eliminate machining defects as a rule-based table and use the table.

More specifically, the corrective machining condition determination unit 34 may hold sets of data including the types of machining defects, correction parameters, and a degree of priority for each of the correction parameters as the defect avoidance data, determine a corrected machining condition on the basis of an inference result and the defect avoidance data, and further correct the corrected machining condition when an inference result on machining using the corrected machining condition indicates poorness compared with a predetermined criterion. The correction parameters are parameters of machining conditions that are to be corrected in avoiding machining defects when machining defects occur. In this case, the laser machining system 1 is capable of modifying a machining condition so that elimination of a machining defect that greatly affects the suspension of the laser beam machine 2 is prioritized.

In cases where plural machining defects occur at the same time, when shared machining parameters that contribute to the elimination of the plural machining defects are present, only values of the shared machining parameters may be changed. Independently of machining defects, a physical model may be used in correcting a machining condition. For example, a thermal lensing effect may be used in a correction formula because there is a model for time and focal shift amount. The thermal lensing effect is a lens effect that arises when an optical component irradiated with a laser beam is heated to have a changed density and a changed refractive index at its heated portion and thus causes a refractive index difference between two parts. In cases where a new machining defect is added, a rule base corresponding to the added machining defect may be added.

On the basis of an inference result on a machining state obtained by the inference unit 31, the corrective machining condition determination unit 34 desirably outputs a corrected machining condition based on proper correction quantities for a machining condition. Machining conditions may be corrected on the basis of predetermined one or more fixed values. For example, in cases where the laser output power is to be adjusted, the laser output power may increase or decrease by 100 watts when a fixed value is set at 100 watts, or may increase or decrease by 5 percent when the fixed value is set as a percentage. The fixed value may be set for each of the machining parameters. The fixed value may be specified by the user.

The parameters that the corrective machining condition determination unit 34 changes include part or all of the laser output power, the machining gas pressure, machining speed, focal position, focused beam diameter, the pulse frequency of the laser, a duty ratio of a pulse, magnification of a zooming optical system inside the machining head 23, a curvature change of adaptive optics (A/O), a type of nozzle, a diameter of the nozzle, a distance between the workpiece 70 and the nozzle, a distance in a laser beam mode, and on/off switching of machining control.

The corrective machining condition determination unit 34 may select machining parameters that are set in a machining condition and are to be output as a corrected machining condition.

During normal machining, the control unit 35 controls, with constituent elements that are not illustrated, the laser oscillator 21 and the motor of the driving unit 24 so that, for example, a laser beam scans a machining path on the workpiece 70 according to the machining program and a set machining condition. The control unit 35 controls the laser oscillator 21 and the driving unit 24 on the basis of the control signal output from the machinery safety unit 33. When the machining condition has been changed, the control unit 35 performs control based on the corrected machining condition that is output from the corrective machining condition determination unit 34.

As described above, the laser machining system 1 according to the first embodiment performs machining, infers a state of a workpiece with a machining signal obtained during the machining, and makes a decision on an anomaly with a machining signal obtained during the machining. The laser machining system 1 uses an inference result and a monitoring result to determine whether to continue or stop the machining and corrects a machining condition. Therefore, the laser machining system 1 is capable of continued machining with the condition appropriate to manufacturing while ensuring safety.

### Second Embodiment

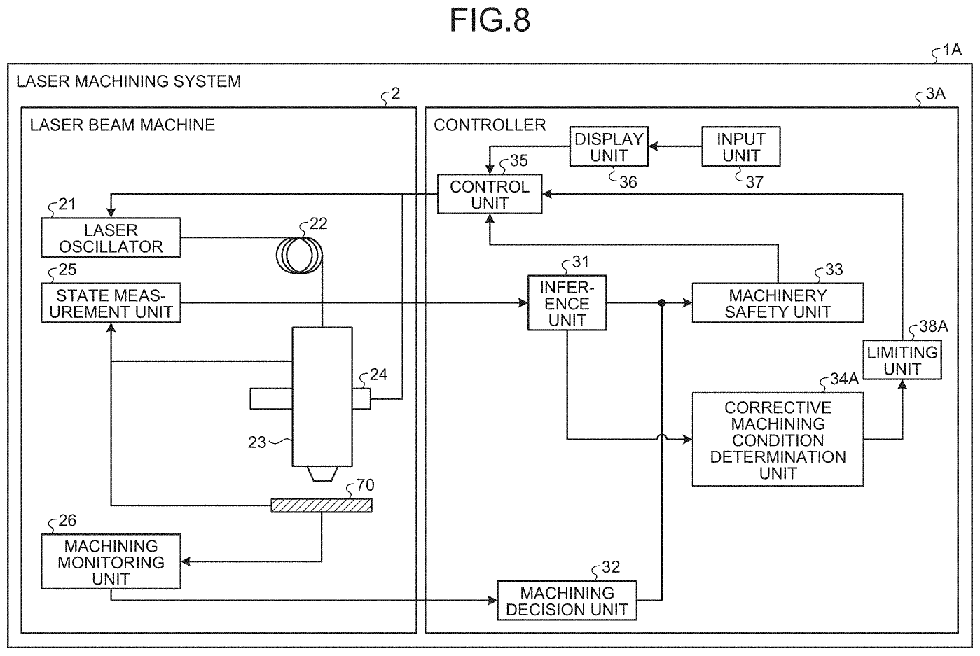

FIG. 8 is a diagram illustrating a configuration of a laser machining system 1A according to a second embodiment. The laser machining system 1A includes the laser beam machine 2 that the laser machining system 1 according to the first embodiment has and a controller 3A that controls the laser beam machine 2. In the second embodiment, a description is provided mainly concerning differences from the first embodiment. The controller 3A includes the inference unit 31, the machining decision unit 32, the machinery safety unit 33, a corrective machining condition determination unit 34A, the control unit 35, the display unit 36, the input unit 37, and a limiting unit 38A. The corrective machining condition determination unit 34A has the functions of the corrective machining condition determination unit 34 according to the first embodiment.

Next, a description on how the laser machining system 1A operates is provided. When machining starts, the state measurement unit 25 and the machining monitoring unit 26 operate as in the first embodiment. The inference unit 31 infers a state of the workpiece 70 on the basis of information obtained by the state measurement unit 25. The machining decision unit 32 makes decisions on anomalies that occur on the front and back faces of the workpiece 70 on the basis of information obtained by the machining monitoring unit 26.

The limiting unit 38A stores machining tolerances and sets, on the basis of the machining tolerances, limit ranges for modifying machining conditions within limited extents. The machining tolerance is a range of machining conditions that provide good machining. The range of good machining conditions, indicated as the machining tolerance, is a range that has taken into consideration stability of the machine and influence on machining caused from assembly errors in a manufacturing procedure, in addition to actual machining results.

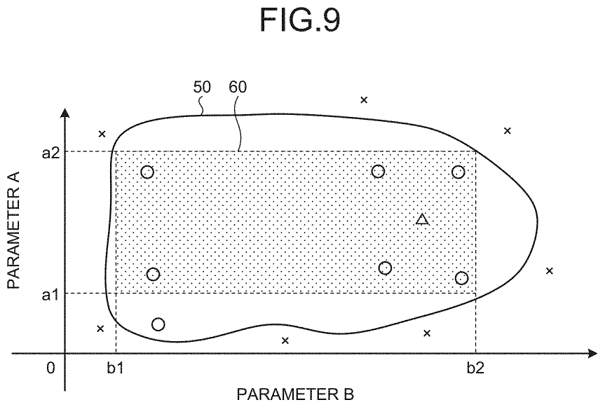

FIG. 9 is a diagram illustrating machining tolerance. The machining tolerance illustrated in FIG. 9 is identified by a parameter A and a parameter B. In FIG. 9, O marks represent machining conditions that have provided good machining, and X marks represent machining conditions that have provided poor machining. A triangular mark represents a machining condition set as a standard machining condition in the laser machining system 1A. A boundary 50 represents a boundary between cases where machining results are good and cases where machining results are poor in a two-dimensional domain defined by the parameters A and B. An area 60 represents a limit range that is set by the limiting unit 38A and reflects the machining tolerance.

A range from a1 to a2 for the parameter A and a range from b1 to b2 for the parameter B are set as the limit range. a2 is larger than a1, and b2 is larger than b1. The limit range is wider than a value of cumulative influence on machining. For example, in cases where a varying thermal lensing phenomenon during machining is targeted with the parameter A being a focal point, if the focal point variations over 2 millimeters due to a thermal lens, then a2 minus a1 should be at least 2 millimeters. The parameter B may be set on a similar basis or may be defined as a percentage, such as a safety factor.

If a user has machining tolerance for a material to be used, the user may enter that machining tolerance into the laser machining system 1A with the input unit 37. In that case, a limit range is reset. The corrective machining condition determination unit 34A outputs a corrected machining condition to the limiting unit 38A.

If the corrected machining condition is a condition within the limit range of the limiting unit 38A, the control unit 35 uses the machining condition output from the corrective machining condition determination unit 34A, and the laser machining system 1A continues machining. If the corrected machining condition is outside the limit range, the laser machining system 1A may stop machining and notify the user of alarm information. The laser machining system 1A notifies the user of the alarm information by, for example, email. The limit range may be set for each of parameters or may be set only for a parameter or parameters that the user wants to optimize. With the limiting unit 38A, the laser machining system 1A is capable of reducing or preventing machining defects that may be caused by corrected machining conditions.

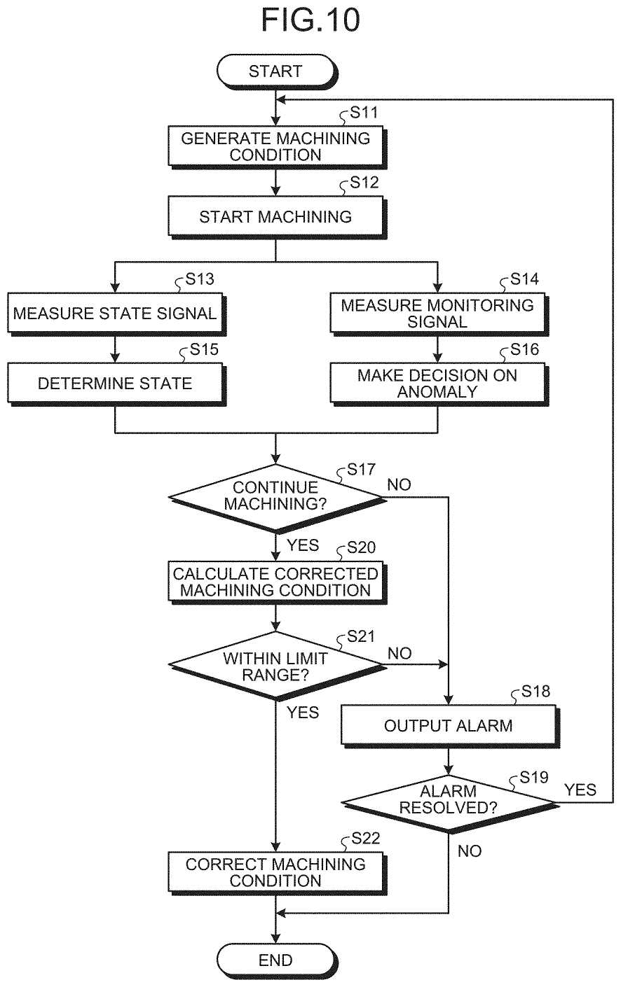

FIG. 10 is a flowchart illustrating an operational procedure of the laser machining system 1A according to the second embodiment. The laser machining system 1A generates a machining condition for machining as in the first embodiment (S11). The machining condition may be generated by the corrective machining condition determination unit 34A of the controller 3A. The machining condition to be generated may be determined on the basis of an inference result on a machining state that is obtained by the inference unit 31. The machining condition to be generated may be specified by the user. The machining condition to be generated needs to be a condition within a limit range set by the limiting unit 38A.

Next, the laser machining system 1A starts the machining based on the machining condition generated (S12). The workpiece 70 is irradiated with a laser beam emitted from the laser oscillator 21, and the state measurement unit 25 detects the varying state of the workpiece 70 and the internal state of the machining head 23 on the basis of a detection start signal and a command (S13). In FIG. 10, the operation of step S13 is phrased as “MEASURE STATE SIGNAL”. The machining monitoring unit 26 detects the varying state of the front face and/or the varying state of the back face of the workpiece 70 during the machining (S14). In FIG. 10, the operation of step S14 is phrased as “MEASURE MONITORING SIGNAL”.

The inference unit 31 extracts a feature based on a detection result of the state measurement unit 25 and determines, with the feature, a quality of the machining (S15). In FIG. 10, the operation of step S15 is phrased as “DETERMINE STATE”. The machining decision unit 32 detects a machining defect through decision using a threshold or an image (S16), on the basis of a detection result of the machining monitoring unit 26. In FIG. 10, the operation of step S16 is phrased as “MAKE DECISION ON ANOMALY”.

The machinery safety unit 33 determines whether to continue the machining or not on the basis of an inference result obtained by the inference unit 31 and a decision result obtained by the machining decision unit 32 (S17). Specifically, the machinery safety unit 33 determines that the machining be continued if the inference result obtained by the inference unit 31 indicates good machining and the decision result obtained by the machining decision unit 32 indicates no defect. If the machining decision unit 32 outputs a determination of an anomaly indicating the defect, the machinery safety unit 33 determines that the machining be suspended, regardless of the result obtained by the inference unit 31.

If the machinery safety unit 33 determines that the machining be suspended (No to S17), the machinery safety unit 33 outputs an alarm (S18). More specifically, if the machining condition determined by the corrective machining condition determination unit 34A is a condition outside the limit range set by the limiting unit 38A, the machinery safety unit 33 determines that the laser beam machining be suspended and outputs the alarm.

The laser machining system 1A suspends the machining if the machinery safety unit 33 determines that the laser beam machining be suspended. The laser machining system 1A determines whether or not the alarm has been resolved (S19). If the laser machining system 1A decides that the alarm has been resolved (Yes to S19), the laser machining system 1A performs the operation of step S11. If the laser machining system 1A decides that the alarm is not resolved (No to S19), the operation of the laser machining system 1A ends.

If the machinery safety unit 33 determines that the machining be continued (Yes to S17), namely if the machinery safety unit 33 outputs a control signal for continued machining, the corrective machining condition determination unit 34A calculates correction quantities appropriate to the inference result obtained by the inference unit 31, calculates a corrected machining condition based on the calculated correction quantities, and outputs the corrected machining condition to the limiting unit 38A (S20). The limiting unit 38A determines whether or not the corrected machining condition is a condition within the limit range based on the stored machining tolerance or the machining tolerance of the user (S21).

If the limiting unit 38A decides that the corrected machining condition is not within the limit range (No to S21), the laser machining system 1A performs the operation of step S18 because a machining defect will occur. If the limiting unit 38A decides that the corrected machining condition is within the limit range (Yes to S21), the control unit 35 modifies the machining condition (S22), and the laser machining system 1A performs next machining.

As described above, the laser machining system 1A according to the second embodiment modifies a machining condition on the basis of a limit range set by the limiting unit 38A. Therefore, the laser machining system 1A obtains the same effects as those obtained by the laser machining system 1 according to the first embodiment and is capable of safer machining. In other words, the laser machining system 1A is a system achieving stability. More specifically, because the laser machining system 1A is provided with the limiting unit 38A, the laser machining system 1A is capable of reducing or preventing machining defects that may be caused by corrected machining conditions.

The user may change the limit range by entering information indicating a limit range into the laser machining system 1A. For example, in cases where a defect occurs during actual machining, the user may change the limit range displayed on the display unit 36 with the input unit 37.

In cases where the corrective machining condition determination unit 34A selects machining parameters that are set in a machining condition and are to be output as a corrected machining condition, the limiting unit 38A may set a limit range for the machining parameters selected by the corrective machining condition determination unit 34A.

### Third Embodiment

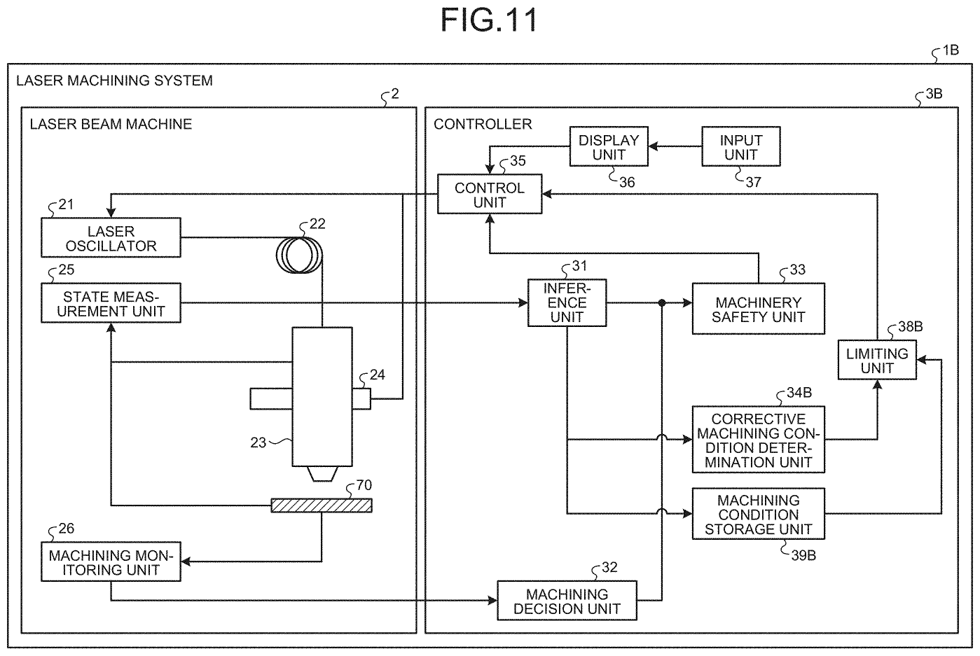

FIG. 11 is a diagram illustrating a configuration of a laser machining system 1B according to a third embodiment. The laser machining system 1B includes the laser beam machine 2 that the laser machining system 1A according to the second embodiment includes and a controller 3B that controls the laser beam machine 2. In the third embodiment, a description is mainly provided concerning differences from the second embodiment. The controller 3B includes the inference unit 31, the machining decision unit 32, the machinery safety unit 33, a corrective machining condition determination unit 34B, the control unit 35, the display unit 36, the input unit 37, a limiting unit 38B, and a machining condition storage unit 39B.

A description is provided next of how the laser machining system 1B operates. As machining starts, the state measurement unit 25 and the machining monitoring unit 26 operate as in the second embodiment. The inference unit 31 infers a state of the workpiece 70 on the basis of information obtained by the state measurement unit 25. The machining decision unit 32 makes decisions on anomalies that occur on the front and back faces of the workpiece 70 on the basis of information obtained by the machining monitoring unit 26. When the inference unit 31 and the machining decision unit 32 output an obtained result to the machining condition storage unit 39B, the obtained result is associated with a machining condition. The machining condition storage unit 39B has a function of storing information. At least part of the machining condition storage unit 39B is implemented, for example, with a semiconductor memory. The machining condition storage unit 39B outputs to the limiting unit 38B stored machining conditions associated with good machining and stored machining conditions associated with poor machining. On the basis of the machining conditions output from the machining condition storage unit 39B, the limiting unit 38B updates a limit range to reset the limit range.

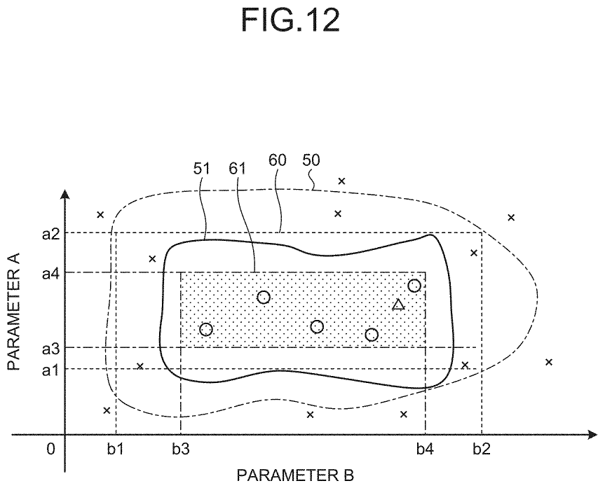

FIG. 12 is a diagram illustrating variation of the machining tolerance according to material states and machining states. As machining continues, either or both of a change of the state of the workpiece 70 due to heat accumulation in the workpiece 70 and a change of the state of the machining head 23 occur; consequently, a machinable area sometimes changes. The machining tolerance illustrated in FIG. 12 is identified by the parameter A and the parameter B. In FIG. 12, O marks represent machining conditions that have provided good machining, and X marks represent machining conditions that have provided poor machining. A triangular mark represents a machining condition set as a standard machining condition in the laser machining system 1B. A boundary 51 represents a boundary between cases where machining results after the change(s) are good and cases where machining results after the change(s) are poor. An area 61 represents a limit range set by the limiting unit 38B and is appropriate to the boundary 51 after the change(s).

The boundary 50 and the area 60 of FIG. 9, are also illustrated in FIG. 12. A machinable area in the case of FIG. 12 is narrow compared with that in the case of FIG. 9. In other words, a range from a3 to a4 for the parameter A and a range from b3 to b4 for the parameter B are set as the limit range. a3 is larger than a1 and smaller than a4. a4 is smaller than a2. b3 is larger than b1 and smaller than b4. b4 is smaller than b2. In cases where machining results are different when machining is performed with the same condition, the limiting unit 38B may thus update a limit range.

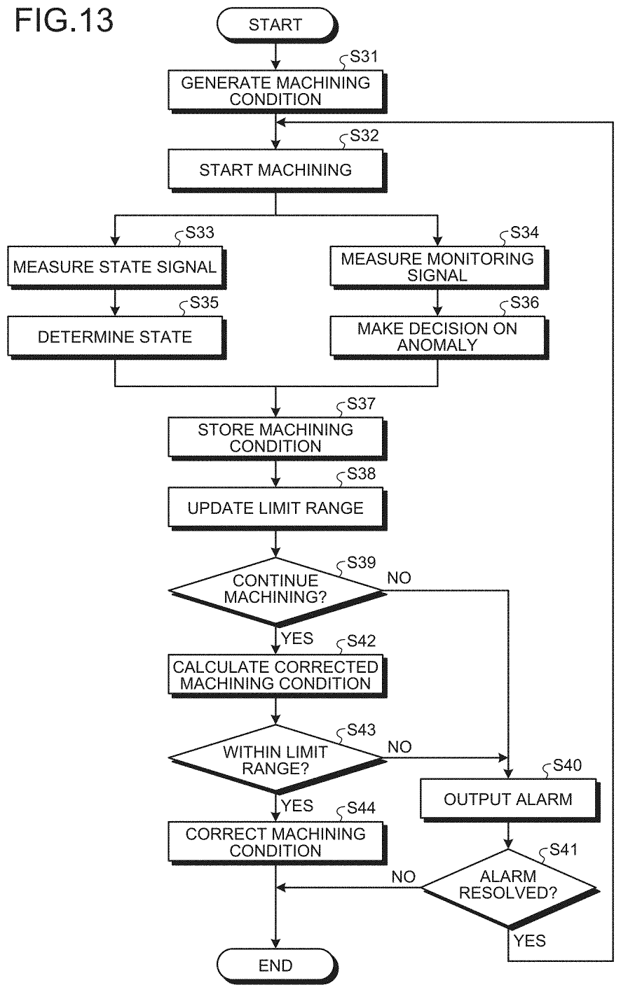

FIG. 13 is a flowchart illustrating an operational procedure of the laser machining system 1B according to the third embodiment. The laser machining system 1B generates a machining condition for machining as in the second embodiment (S31). The corrective machining condition determination unit 34B of the controller 3B may generate the machining condition. The machining condition to be generated may be determined on the basis of an inference result on a machining state that is obtained by the inference unit 31. The machining condition to be generated needs to be a condition within a limit range set by the limiting unit 38B.

Next, the laser machining system 1B starts the machining based on the machining condition generated at step S31 (S32). The workpiece 70 is irradiated with a laser beam emitted from the laser oscillator 21, and the state measurement unit 25 detects the varying state of the workpiece 70 and the internal state of the machining head 23 on the basis of a machining start signal (S33). In FIG. 13, the operation of step S33 is phrased as “MEASURE STATE SIGNAL”. The machining monitoring unit 26 detects the varying state of the front face and/or the varying state of the back face of the workpiece 70 during the machining (S34). In FIG. 13, the operation of step S34 is phrased as “MEASURE MONITORING SIGNAL”.

The inference unit 31 extracts a feature based on a detection result of the state measurement unit 25 and determines, with the feature, a quality of the machining (S35). In FIG. 13, the operation of step S35 is phrased as “INFER STATE”. The machining decision unit 32 detects a machining defect through decision using a threshold or an image, on the basis of a detection result of the machining monitoring unit 26 (S36). In FIG. 13, the operation of step S36 is phrased as “MAKE DECISION ON ANOMALY”.

Regardless of a machining result, the machining condition storage unit 39B stores the machining condition together with an inference result and stores the machining condition together with a decision result (S37). The limiting unit 38B refers to the information stored in the machining condition storage unit 39B and updates the limit range (S38).

The machinery safety unit 33 determines whether or not to continue the machining on the basis of the inference result obtained by the inference unit 31 and the decision result obtained by the machining decision unit 32 (S39). Specifically, the machinery safety unit 33 determines that the machining be continued if the inference result obtained by the inference unit 31 indicates good machining and the decision result obtained by the machining decision unit 32 indicating no defect. If the machining decision unit 32 outputs a determination of an anomaly indicating the defect, the machinery safety unit 33 determines that the machining be suspended, regardless of the result obtained by the inference unit 31.

If the machinery safety unit 33 determines that the machining be suspended (No to S39), the machinery safety unit 33 outputs an alarm (S40). More specifically, if the corrected machining condition determined by the corrective machining condition determination unit 34B is a condition outside the limit range set by the limiting unit 38B, the machinery safety unit 33 determines that the laser beam machining be suspended and outputs the alarm.

The laser machining system 1B suspends the machining if the machinery safety unit 33 determines that the laser beam machining be suspended. The laser machining system 1B determines whether or not the alarm has been resolved (S41). If the laser machining system 1B decides that the alarm has been resolved (Yes to S41), the laser machining system 1B performs the operation of step S32. If the laser machining system 1B decides that the alarm is not resolved (No to S41), the operation of the laser machining system 1B ends.

If the machinery safety unit 33 determines that the machining be continued (Yes to S39), namely if the machinery safety unit 33 outputs a control signal for continued machining, the corrective machining condition determination unit 34B calculates correction quantities appropriate to the inference result obtained by the inference unit 31, calculates a corrected machining condition based on the calculated correction quantities, and outputs the corrected machining condition to the limiting unit 38B (S42). The limiting unit 38B determines whether or not the corrected machining condition output from the corrective machining condition determination unit 34B is a condition within the updated limit range (S43).

If the limiting unit 38B decides that the corrected machining condition is not within the limit range (No to S43), the laser machining system 1B performs the operation of step S40 because a machining defect will occur. If the limiting unit 38B decides that the corrected machining condition is within the limit range (Yes to S43), the control unit 35 modifies the machining condition (S44), and the laser machining system 1B performs next machining.

As described above, the laser machining system 1B according to the third embodiment can achieve stability even if the machining tolerance varies according to the state of the workpiece 70 or the variations.

As described above, good machining conditions and poor machining conditions are output to the machining condition storage unit 39B by the inference unit 31 at the same time as inference results on the quality. Good machining conditions and poor machining conditions are output to the machining condition storage unit 39B by the machining decision unit 32 at the same time as decision results on the quality. The machining condition storage unit 39B receives the inference results, the good machining conditions, and the poor machining conditions from the inference unit 31 and stores the inference results as machining result data in association with the good machining conditions and the poor machining conditions. The machining condition storage unit 39B receives the decision results, the good machining conditions, and the poor machining conditions from the machining decision unit 32 and stores the decision results as machining result data in association with the good machining conditions and the poor machining conditions.

The machining condition storage unit 39B outputs numerical ranges to be used at the time of modification of condition to the limiting unit 38B. The machining condition storage unit 39B stores a machining condition for which a decision result obtained by the machining decision unit 32 and an inference result obtained by the inference unit 31 both indicate goodness as a good machining condition, and stores a machining condition for which a decision result obtained by the machining decision unit 32 indicates poorness as a poor machining condition. The machining condition storage unit 39B may store a machining condition for which a decision result and an inference result indicate goodness compared with predetermined criteria as a good machining condition, and store a machining condition for which a decision result and an inference result indicate poorness compared with the predetermined criteria as a poor machining condition.

Parameters that the machining condition storage unit 39B stores include part or all of: the laser output power, the machining gas pressure, machining speed, focal position, focused beam diameter, the pulse frequency of the laser, a duty ratio of a pulse, magnification of a zooming optical system inside the machining head 23, a curvature change of adaptive optics, a type of nozzle, a diameter of the nozzle, a distance between the workpiece 70 and the nozzle, a distance in a laser beam mode, and on/off switching of machining control.

The machining condition storage unit 39B may store parameters other than the above-mentioned parameters. The parameters that the machining condition storage unit 39B stores are non-limiting as long as these parameters can be set for laser beam machining. The machining condition storage unit 39B may store a numerical table about design information for machining conditions, machining tolerance information used in past condition development, output stability of the laser oscillator 21, or cooling ability of the machining head 23.

The limiting unit 38B redetermines the limit range on the basis of the good and poor machining conditions stored in the machining condition storage unit 39B. The limiting unit 38B operates in the same manner as the limiting unit 38A according to the second embodiment, except that the limiting unit 38B refers to the results stored in the machining condition storage unit 39B and updates the limit range.

The machinable area narrows or widens, depending on, for example, the state of the front face of the workpiece 70. Therefore, a user may update numerical ranges of machining parameters set in the limiting unit 38B. In other words, the user may widen or narrow the numerical ranges of the machining parameters. The user may set the numerical ranges so that the ranges automatically vary according to situations. The numerical ranges may be updated on the basis of machining record data after machining is performed a preset number of times or by reference to machining record data after each machining.

As described above, the laser machining system 1B according to the third embodiment modifies a machining condition on the basis of a limit range set by the limiting unit 38B. Therefore, the laser machining system 1B obtains the same effects as those obtained by the laser machining system 1 according to the first embodiment and the laser machining system 1A according to the second embodiment. In addition, the laser machining system 1B is capable of properly performing machining suited to a purpose in a shorter time.

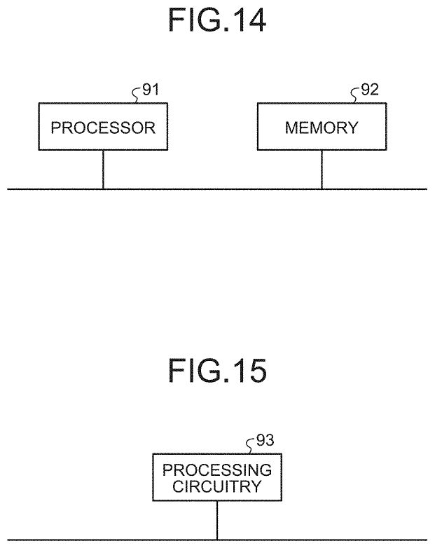

FIG. 14 is a diagram illustrating a processor 91 in cases where the processor 91 is used to implement at least part of the inference unit 31, the machining decision unit 32, the machinery safety unit 33, the corrective machining condition determination unit 34, the control unit 35, the display unit 36, and the input unit 37 of the controller 3 of the laser machining system 1 according to the first embodiment. In other words, at least part of the functions of the inference unit 31, the machining decision unit 32, the machinery safety unit 33, the corrective machining condition determination unit 34, the control unit 35, the display unit 36, and the input unit 37 may be implemented with the processor 91 that executes programs stored in a memory 92. The processor 91 is a central processing unit (CPU), a processing unit, an arithmetic unit, a microprocessor, or a digital signal processor (DSP). The memory 92, too, is illustrated in FIG. 14.

In cases where the at least part of the functions of the inference unit 31, the machining decision unit 32, the machinery safety unit 33, the corrective machining condition determination unit 34, the control unit 35, the display unit 36, and the input unit 37 is implemented with the processor 91, the at least part of the functions is implemented with the processor 91 and software, firmware, or a combination of software and firmware. The software or the firmware is described as programs and is stored in the memory 92. The processor 91 reads and executes the programs stored in the memory 92 to implement the at least part of the functions of the inference unit 31, the machining decision unit 32, the machinery safety unit 33, the corrective machining condition determination unit 34, the control unit 35, the display unit 36, and the input unit 37.

In cases where the at least part of the functions of the inference unit 31, the machining decision unit 32, the machinery safety unit 33, the corrective machining condition determination unit 34, the control unit 35, the display unit 36, and the input unit 37 is implemented with the processor 91, the memory 92 is included in the laser machining system 1 to store the programs with which the at least part of the steps of the inference unit 31, the machining decision unit 32, the machinery safety unit 33, the corrective machining condition determination unit 34, the control unit 35, the display unit 36, and the input unit 37 is resultantly executed. The programs stored in the memory 92 can be said to cause a computer to perform at least part of procedures or methods of the inference unit 31, the machining decision unit 32, the machinery safety unit 33, the corrective machining condition determination unit 34, the control unit 35, the display unit 36, and the input unit 37.

The memory 92 is, for example, a nonvolatile or volatile semiconductor memory such as a random-access memory (RAM), a read-only memory (ROM), a flash memory, an erasable programmable read-only memory (EPROM), or an electrically erasable programmable read-only memory (EEPROM) (registered trademark), a magnetic disk, a flexible disk, an optical disk, a compact disk, a mini disk, or a digital versatile disk (DVD).

FIG. 15 is a diagram illustrating processing circuitry 93 in cases where the processing circuitry 93 is used to implement at least part of the inference unit 31, the machining decision unit 32, the machinery safety unit 33, the corrective machining condition determination unit 34, the control unit 35, the display unit 36, and the input unit 37 of the controller 3 of the laser machining system 1 according to the first embodiment. In other words, the at least part of the inference unit 31, the machining decision unit 32, the machinery safety unit 33, the corrective machining condition determination unit 34, the control unit 35, the display unit 36, and the input unit 37 may be implemented with the processing circuitry 93.

The processing circuitry 93 is dedicated hardware. The processing circuitry 93 is, for example, a single circuit, a composite circuit, a programmed processor, a parallel programmed processor, an application-specific integrated circuit (ASIC), a field-programmable gate array (FPGA), or a combination of these.

Part of the inference unit 31, the machining decision unit 32, the machinery safety unit 33, the corrective machining condition determination unit 34, the control unit 35, the display unit 36, and the input unit 37 may be implemented with different dedicated hardware separately from a remaining part.

Part of the plural functions of the inference unit 31, the machining decision unit 32, the machinery safety unit 33, the corrective machining condition determination unit 34, the control unit 35, the display unit 36, and the input unit 37 may be implemented with software or firmware, while a remaining part of the plural functions may be implemented with dedicated hardware. As described above, the plural functions of the inference unit 31, the machining decision unit 32, the machinery safety unit 33, the corrective machining condition determination unit 34, the control unit 35, the display unit 36, and the input unit 37 are implementable with the hardware, the software, the firmware, or the combination of these.

At least part of the functions of the driving unit 24, the state measurement unit 25, and the machining monitoring unit 26 of the laser beam machine 2 of the laser machining system 1 according to the first embodiment may be implemented with a processor that executes programs stored in a memory. The memory is the same as the memory 92, and the processor is the same as the processor 91. At least part of the driving unit 24, the state measurement unit 25, and the machining monitoring unit 26 may be implemented with processing circuitry. The processing circuitry is the same as the processing circuitry 93.

At least part of the functions of the inference unit 31, the machining decision unit 32, the machinery safety unit 33, the corrective machining condition determination unit 34A, the control unit 35, the display unit 36, the input unit 37, and the limiting unit 38A of the controller 3A of the laser machining system 1A according to the second embodiment may be implemented with a processor that executes programs stored in a memory. The memory is the same as the memory 92, and the processor is the same as the processor 91. At least part of the inference unit 31, the machining decision unit 32, the machinery safety unit 33, the corrective machining condition determination unit 34A, the control unit 35, the display unit 36, the input unit 37, and the limiting unit 38A of the controller 3A may be implemented with processing circuitry. The processing circuitry is the same as the processing circuitry 93.

At least part of the functions of the inference unit 31, the machining decision unit 32, the machinery safety unit 33, the corrective machining condition determination unit 34B, the control unit 35, the display unit 36, the input unit 37, the limiting unit 38B, and the machining condition storage unit 39B of the controller 3B of the laser machining system 1B according to the third embodiment may be implemented with a processor that executes programs stored in a memory. The memory is the same as the memory 92, and the processor is the same as the processor 91. At least part of the inference unit 31, the machining decision unit 32, the machinery safety unit 33, the corrective machining condition determination unit 34B, the control unit 35, the display unit 36, the input unit 37, the limiting unit 38B, and the machining condition storage unit 39B of the controller 3B may be implemented with processing circuitry. The processing circuitry is the same as the processing circuitry 93.

The above configurations illustrated in the embodiments are illustrative, can be combined with other techniques that are publicly known, and can be partly omitted or changed without departing from the gist. The embodiments can be combined together.

### REFERENCE SIGNS LIST

1, 1A, 1B laser machining system; 2 laser beam machine; 3, 3A, 3B controller; 21 laser oscillator; 22 optical path; 23 machining head; 24 driving unit; 25 state measurement unit; 26 machining monitoring unit; 31 inference unit; 32 machining decision unit; 33 machinery safety unit; 34, 34A, 34B corrective machining condition determination unit; 35 control unit; 36 display unit; 37 input unit; 38A, 38B limiting unit; 39B machining condition storage unit; 44 learning unit; 45 data acquisition unit; 46 model generation unit; 47 learned model storage unit; 70 workpiece; 91 processor; 92 memory; 93 processing circuitry.

1.-11. (canceled)

12. A laser machining system comprising:
a driver to change relative positions of a machining head that focuses a beam emitted from a laser oscillator in irradiating a workpiece and the workpiece;
processing circuitry
to determine operation commands for the driver and the laser oscillator on a basis of a control signal and a machining condition specifying parameters and numerical values for laser beam machining;
to observe, during laser beam machining, an internal state of the machining head or a varying state of the workpiece and output an observation result as a machining state signal;
to determine a degree of quality of the laser beam machining as an inference result, the degree of quality being inferred for each of machining defects concerning at least one type of machining defect on a basis of the machining state signal;
to monitor the workpiece for presence or absence of the machining defect and output a monitoring result as a monitoring signal;
to decide whether or not there is the at least one type of machining defect on a basis of the monitoring signal and determine a quality of the laser beam machining as a decision result; and
to output, on a basis of the inference result and the decision result, the control signal that gives an instruction on whether to stop or continue the laser beam machining, wherein
the processing circuitry determines a monitoring command for instructing to determine the decision result when the inference result on the at least one type of machining defect indicates that the degree of quality is poor compared with a predetermined criterion.

13. The laser machining system according to claim 12, wherein
the processing circuitry determines a stop command for stopping machining when determining a machining defect from the decision result on the at least one type of machining defect.

14. A laser machining system comprising:
a driver to change relative positions of a machining head that focuses a beam emitted from a laser oscillator in irradiating a workpiece and the workpiece;
processing circuitry
to determine operation commands for the driver and the laser oscillator on a basis of a control signal and a machining condition specifying parameters and numerical values for laser beam machining;
to observe, during laser beam machining, an internal state of the machining head or a varying state of the workpiece and output an observation result as a machining state signal;
to determine a degree of quality of the laser beam machining as an inference result, the degree of quality being inferred for each of machining defects concerning at least one type of machining defect on a basis of the machining state signal;
to monitor the workpiece for presence or absence of the machining defect and output a monitoring result as a monitoring signal;
to decide whether or not there is the at least one type of machining defect on a basis of the monitoring signal and determine a quality of the laser beam machining as a decision result; and
to output, on a basis of the inference result and the decision result, the control signal that gives an instruction on whether to stop or continue the laser beam machining, wherein
the processing circuitry determines a cyclic modulation command for instructing to change a decision cycle to a shorter cycle when the inference result on the at least one type of machining defect indicates that the degree of quality is poor compared with a predetermined criterion, the decision cycle being an interval of time for the decision result to be determined.

15. The laser machining system according to claim 12, wherein
the processing circuitry further corrects the machining condition on a basis of the inference result in determining a corrected machining condition; and
sets a limit range for modifying the machining condition within a limited extent, wherein
the processing circuitry determines that the laser beam machining be suspended when the corrected machining condition determined is a condition outside the limit range set.

16. The laser machining system according to claim 14, wherein
the processing circuitry further corrects the machining condition on a basis of the inference result in determining a corrected machining condition; and
sets a limit range for modifying the machining condition within a limited extent, wherein
the processing circuitry determines that the laser beam machining be suspended when the corrected machining condition determined is a condition outside the limit range set.

17. The laser machining system according to claim 15, further comprising
a machining condition storage to store the machining condition that causes the decision result and the inference result to indicate goodness compared with predetermined criteria as a good machining condition, and store the machining condition that causes the decision result and the inference result to indicate poorness compared with the predetermined criteria as a poor machining condition, wherein
the processing circuitry redetermines the limit range on a basis of the good machining condition and the poor machining condition that are stored in the machining condition storage.

18. The laser machining system according to claim 16, further comprising
a machining condition storage to store the machining condition that causes the decision result and the inference result to indicate goodness compared with predetermined criteria as a good machining condition, and store the machining condition that causes the decision result and the inference result to indicate poorness compared with the predetermined criteria as a poor machining condition, wherein
the processing circuitry redetermines the limit range on a basis of the good machining condition and the poor machining condition that are stored in the machining condition storage.

19. A laser machining system comprising:
a driver to change relative positions of a machining head that focuses a beam emitted from a laser oscillator in irradiating a workpiece and the workpiece;
processing circuitry
to determine operation commands for the driver and the laser oscillator on a basis of a control signal and a machining condition specifying parameters and numerical values for laser beam machining;
to observe, during laser beam machining, an internal state of the machining head or a varying state of the workpiece and output an observation result as a machining state signal;
to determine a degree of quality of the laser beam machining as an inference result, the degree of quality being inferred for each of machining defects concerning at least one type of machining defect on a basis of the machining state signal;
to monitor the workpiece for presence or absence of the machining defect and output a monitoring result as a monitoring signal;
to decide whether or not there is the at least one type of machining defect on a basis of the monitoring signal and determine a quality of the laser beam machining as a decision result;
to output, on a basis of the inference result and the decision result, the control signal that gives an instruction on whether to stop or continue the laser beam machining; and
to correct the machining condition on a basis of the inference result in determining a corrected machining condition; and
to set a limit range for modifying the machining condition within a limited extent, wherein
the processing circuitry determines that the laser beam machining be suspended when the corrected machining condition determined is a condition outside a limit range set, and
the processing circuitry holds sets of data including the types of machining defects, correction parameters, and a degree of priority for each of the correction parameters as defect avoidance data, determines the corrected machining condition on a basis of the inference result and the defect avoidance data, and further corrects the corrected machining condition when the inference result on machining using the corrected machining condition indicates poorness compared with a predetermined criterion, each of the correction parameters being a parameter of the machining condition that is to be corrected in avoiding the machining defect when the machining defect occurs.

20. The laser machining system according to claim 15, wherein
the processing circuitry selects machining parameters that are set in the machining condition and are to be output as the corrected machining condition.

21. The laser machining system according to claim 16, wherein
the processing circuitry selects machining parameters that are set in the machining condition and are to be output as the corrected machining condition.

22. The laser machining system according to claim 19, wherein
the processing circuitry selects machining parameters that are set in the machining condition and are to be output as the corrected machining condition.

23. The laser machining system according to claim 20, wherein
the processing circuitry sets the limit range for the machining parameters selected.

24. The laser machining system according to claim 21, wherein
the processing circuitry sets the limit range for the machining parameters selected.

25. The laser machining system according to claim 22, wherein
the processing circuitry sets the limit range for the machining parameters selected.

26. A laser machining system comprising:
a driver to change relative positions of a machining head that focuses a beam emitted from a laser oscillator in irradiating a workpiece and the workpiece;
processing circuitry
to determine operation commands for the driver and the laser oscillator on a basis of a control signal and a machining condition specifying parameters and numerical values for laser beam machining;
to observe, during laser beam machining, an internal state of the machining head or a varying state of the workpiece and output an observation result as a machining state signal;
to determine a degree of quality of the laser beam machining as an inference result, the degree of quality being inferred for each of machining defects concerning at least one type of machining defect on a basis of the machining state signal;
to monitor the workpiece for presence or absence of the machining defect and output a monitoring result as a monitoring signal;
to decide whether or not there is the at least one type of machining defect on a basis of the monitoring signal and determine a quality of the laser beam machining as a decision result; and
to output, on a basis of the inference result and the decision result, the control signal that gives an instruction on whether to stop or continue the laser beam machining, wherein
the processing circuitry
obtains training data including the machining state signal and teacher labels indicating that the workpiece is good and poor, and
uses the training data in generating a learned model that infers a degree of quality of the laser beam machining.

27. The laser machining system according to claim 12, further comprising
at least one of an acoustic sensor, an optical sensor, an acceleration sensor, or a temperature sensor, and
at least one of an acoustic sensor, an optical sensor, a camera, a vibration sensor, or a distance sensor.

28. The laser machining system according to claim 14, further comprising
at least one of an acoustic sensor, an optical sensor, an acceleration sensor, or a temperature sensor, and
at least one of an acoustic sensor, an optical sensor, a camera, a vibration sensor, or a distance sensor.

29. The laser machining system according to claim 19, further comprising
at least one of an acoustic sensor, an optical sensor, an acceleration sensor, or a temperature sensor, and
at least one of an acoustic sensor, an optical sensor, a camera, a vibration sensor, or a distance sensor.

30. The laser machining system according to claim 26, further comprising
at least one of an acoustic sensor, an optical sensor, an acceleration sensor, or a temperature sensor, and
at least one of an acoustic sensor, an optical sensor, a camera, a vibration sensor, or a distance sensor.
